(19) United States
(12) Patent Application Publication
(10) Pub. No.: US 2008/0033980 A1
(43) Pub. Date: Feb. 7, 2008

(54) System and method for automatically adjusting file system settings

(76) Inventor: Jaroslav Andrew Delapedraja, Ft. Collins, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/498,377

(22) Filed: Aug. 3, 2006

(51) Int. Cl. G06F 7/00

(52) U.S. Cl. 707/102

(57) ABSTRACT

There is provided a system and method for automatically adjusting file system settings. More specifically, in one embodiment, there is provided a a method comprising accessing a data file containing performance data for a computer, wherein the data file was created by a stacked module, identifying a setting of the computer associated with the performance data, and automatically adjusting the setting based on the performance data.

### BACKGROUND

This section is intended to introduce the reader to various aspects of art, which may be related to various aspects of the present invention that are described and claimed below. This discussion is believed to be helpful in providing the reader with background information to facilitate a better understanding of the various aspects of the present invention. Accordingly, it should be understood that these statements are to be read in this light, and not as admissions of prior art.

Over the past few years, computers and computer-related technologies have become an integral part of the lives of more and more people. Many people now rely on computers for a variety of tasks, such as shopping, investing, and/or banking. As most people are aware, computer filing systems, and, thus, computer files, underlie most of these activities. For example, a document may be stored in one file, a spreadsheet in another, and a photograph in yet another. These files are then stored on a storage device, such as a hard drive, which is organized under the control of a file system, such as Windows, Mac OS, or UNIX. Modern computers typically stores tens of thousands or more computer files, and it is the responsibility of the computer's file system to manage the storage, organization, manipulation, navigation, access, and/or retrieval of these computer files or other data. For this reason, the efficiency of the computer system's file system directly impacts the computer's overall efficiency.

Many modern file systems (e.g., VxFS produced by Veritas, ZFS produced by Solaris, Linux, and so-forth) provide a variety of system settings, such as internal buffer size, read-ahead buffer size, and so-forth, that users can set to affect the performance of the file system. For example, setting the internal buffer size high may decrease the processing times for larger files but increase the processing times for smaller files. Typically, file systems are pre-programmed from the factory with default system settings configured for generic use. However, as these default system settings do not account for the file system's exact function, performance of the file system (and, thus, the computer system) can be improved by “tuning” these system settings to the function and/or operation of the individual computer system running the file system. Disadvantageously, such manual tuning has conventionally been skill intensive, difficult, and time consuming.

### BRIEF DESCRIPTION OF THE DRAWINGS

FIG. 1 is a block diagram of an exemplary computer system in accordance with one embodiment;

FIG. 2 is a block diagram of an exemplary system for automatically adjusting file system settings in accordance with one embodiment;

FIG. 3 is a flow chart illustrating an exemplary technique for automatically adjusting file system settings in accordance with one embodiment; and

FIG. 4 is a flow chart illustrating another exemplary technique for automatically adjusting file system settings in accordance with one embodiment.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, manually adjusting or “tuning” file system settings may be skill intensive, time consuming, and/or difficult. Accordingly, one or more of the embodiments described herein may be directed towards a system or method for automatically adjusting file system settings. More specifically, in one embodiment, there is provided a tuning system for a computer file system comprising a trace module configured to be stacked onto the file system and to generate a log file containing data intercepted enroute to the file system, and a tuning module configured to adjust one or more file system setting based one or more characteristics of the intercepted data.

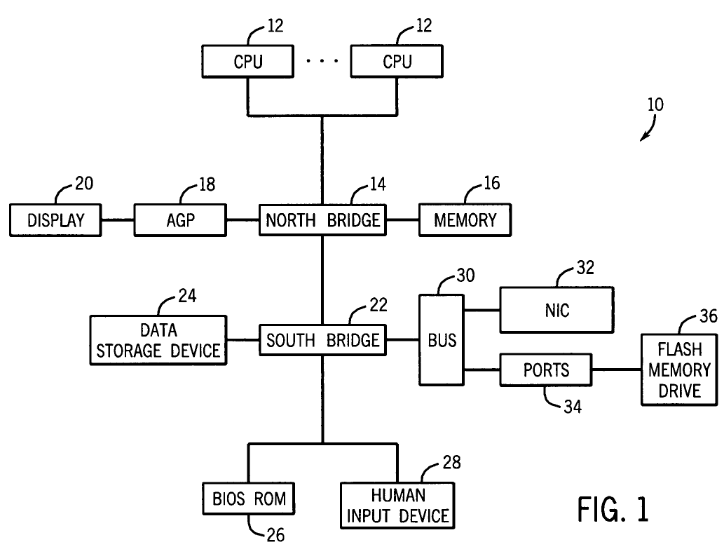

Turning now to FIG. 1, a block diagram of an exemplary computer system configured to generate provisioning information for itself in accordance with one embodiment is illustrated and generally designated by a reference numeral 10. The computer system 10 may include one or more processors or central processing units (“CPUs”) 12. While the CPU 12 will be referred to primarily in the singular, it will be understood that a computer system 10 with any number of physical or logical CPUs 12 may be implemented. Examples of suitable CPUs 12 include the Intel Pentium 4 Processor, the Intel Xeon Processor, the AMD Opteron, and so-forth.

The CPU 12 may be communicatively coupled to a north bridge 14, such as an Intel 82451NX Memory and I/O Bridge Controller (“MIOC”). The north bridge 14 may be an interface (either directly or indirectly) between the CPU 12 and the rest of the components of the system 10. The north bridge 14 may contain a memory controller for accessing a main memory 16 (e.g., dynamic random access memory (“DRAM”)). The north bridge 14 may also be communicatively coupled to an accelerated graphics port (“AGP”) 18. The AGP 18 can transmit video data through an AGP video card (not shown) to a video display 20, which can display the video data for a user. In alternate embodiments, the north bridge 14 may be replaced or supplemented with a memory controller hub (“MCH”) or other suitable component.

The north bridge 14 may also be communicatively coupled to a south bridge 22. The south bridge 22 is an integrated multifunctional component, such as the Intel 82371. The south bridge 22 may include a controller which may enable the south bridge 22 to communicate and/or control a data storage device 24. The data storage device 24 may include any one of a variety of suitable data storage devices. For example, in one embodiment, the data storage device 24 is an IDE or ATA hard drive. In alternate embodiments, the data storage device 24 may be a small computer system interface (“SCSI”) drive or a fibre channel drive. In still other embodiments, the data storage device 24 may be a solid state data storage device or optical data storage device. Moreover, in alternate embodiments, the south bridge 22 may be replaced or supplemented with an input/output control hub (“ICH”) or other suitable component. Further, in some embodiments, the functionality of the south bridge 22 and north bridge 14 (amongst other functions) may be combined into a single component.

The south bridge may also be coupled to a basic input/output system (“BIOS”) read-only memory (“ROM”) 26. The BIOS ROM 26 may be configured to store code or instructions for setting up or configuring the operation of the computer system 10. The south bridge 22 may also be coupled to a variety of human input devices 28, such as the keyboard and/or a mouse. Further, while not illustrated in FIG. 1, the south bridge 22 may also include an enhanced direct memory access (“DMA”) controller; an interrupt controller; a timer; a universal serial bus (“USB”) host controller for providing a universal serial bus (not shown); and an industry standard architecture (“ISA”) bus controller for providing an ISA bus (not shown). In one embodiment (not shown), the south bridge 22 may be coupled to the BIOS ROM 26 and the human input device 28 via a super I/O processor or other suitable interface component.

The south bridge 22 may also be communicatively coupled to an expansion bus 30. The expansion bus 30 may permit the addition of expansion cards into the computer system 10. The expansion bus 30 may employ any one of a number of suitable expansion bus technologies, including Peripheral Component Interconnect (“PCI”), PCI-X, PCI express, and the like. As such, it will be appreciated that PCI, PCI-X, and PCI express are merely exemplary, and in alternate embodiments, other suitable expansion bus technologies may be employed as well.

The expansion bus 30 may be coupled to a network interface card (“NIC”) 32. As will be appreciated, the NIC 32 may enable the computer system 10 to communicate with other computer systems and/or devices over a computer network. For example, in one embodiment, the computer system 10 functions as a server for a computer network. In this embodiment, the computer system 10 may communicate with one or more client computer systems (not shown) and/or applications via the NIC 32. As will be appreciated, the NIC 32 may employ a variety of communication protocols, either wired or wireless, depending on the type of computer network that the computer system 10 is configured to employ.

The expansion bus 30 may be communicatively coupled to one or more ports 34. The expansion bus 30 may include any one of a number of suitable expansion buses, such as universal serial bus (“USB”), USB2, IEEE-1394, SATA, and so forth. The ports 34 may also be communicatively coupled any one of a number of external systems or devices, including storage devices, remote computers, and the like.

Further, it should be noted that the embodiment of the computer system 10 illustrated in FIG. 1 is merely one exemplary embodiment of the computer system 10. For example, in alternate embodiments, the computer system 10 may include thin client systems, distributed computer systems, servers, personal digital assistants, and/or wireless telephones. As such, in alternate embodiments, the above described elements may be reconfigured and/or certain elements omitted from the computer system 10. For example, as described above, in one alternate embodiment, the north bridge 14 and the south bridge 22 may be replaced by a single integrated chipset. In still other embodiments, the memory 16 and/or the ports 34 may be coupled directly to the CPU 12.

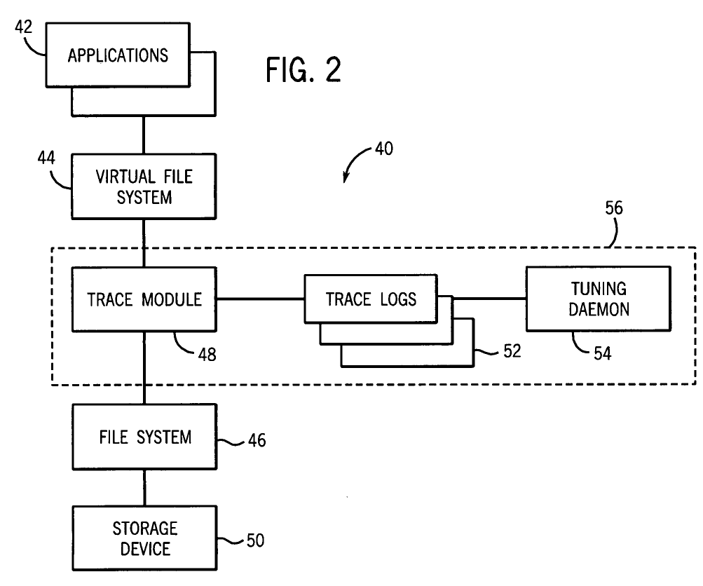

Turning next to FIG. 2, a block diagram of an exemplary system for automatically adjusting file system settings in accordance with one embodiment is illustrated and generally designated by a reference numeral 40. As illustrated in FIG. 2, the system 40 may include a plurality of components (blocks 42-54). The components may be hardware, software, or some combination of hardware and software. Additionally, it will be appreciated that the components shown in FIG. 2 are merely one example and other embodiments can be envisaged wherein the component's functions are split up differently or wherein some components are not included or other components are included. Moreover, in one embodiment, a user may incorporate the functionality of the system 40 to automatically adjust file system settings of the computer system 10. For example, in one embodiment, code adapted to enable the CPUs 12 to function as one or more of the components of the system 40 may be stored in the memory 16 and/or the data storage device 24. However, in alternate embodiments, the components of the system 40 may be separate processors and/or storage devices integrated into the computer system 10.

As described above, the system 40 may comprise a plurality of components. One of these components may be one or more applications 42. The applications 42 may include any one of a number of suitable software programs, such as an operating system, a word processing program, a financial programs, a network or administrative program, and so-forth. In one embodiment, the applications 42 may run on the computer system 10. However, in alternate embodiments, one or more of the applications 42 may be running on a remote computer that communicates with the computer system 10 via the NIC 32 or another suitable networking device.

As illustrated in FIG. 2, the applications 42 may communicate with a virtual file system (“VFS”) 44 through one or more application program interfaces (“APIs”) provided by an operating system. The VFS 44 may provide a uniform access mechanism to a file system, such as file system 46 (described below), that is not dependent on the details of the operation of the file system 46. The VFS 44 may enable multiple different file systems to work together on the computer system 10. For example, the VFS 44 can be used to bridge the differences in specific file systems, such that the applications 42 can access files stored on any of these types of file systems without having to know what type of file system 46 they are accessing. In other words, the VFS 44 provides a generic file system interface that receives file system commands and translates them, as appropriate, to access data on a particular non-generic file system (e.g., Solaris's ZFS and VxFS).

The VFS 44 may be coupled to a trace module 48 (described in detail further below), which is coupled to the file system 46. The file system 46 provides a system for storing and/or organizing computer files within the computer system 10. As described above, modern computer systems may include tens of thousands or more computer files that contain data, such as documents, pictures, and so-forth. The file system 46 may be configured to manage the storage, organization, manipulation, navigation, access, and retrieval of that data (in the form of data files) from a storage device 50, such as the data storage device 24 described in regard to FIG. 1. In one embodiment, the file system 46 may include VxFS file system produced by Veritas software. In alternate embodiments, however, the file system 46 may include other suitable file systems, such as ZFS produced by Sun Microsystems, LINUX, UNIX, and so-forth. Moreover, it will be appreciated that the above-described file systems are merely exemplary and, as such, are not intended to describe every potential embodiment of the file system 46.

As will be further appreciated, the storage and organization of tens of thousands of files may be complex. As such, designing and testing the file system 46 may involve thousands of hours or more. Often, the file system 46 may include thousands of lines of complex, interdependent computer code. Due to the complexity and interdependency of the code underlying the file system 46, adding additional functionality into the file system code itself can be difficult and, more importantly, may jeopardize the functionality and/or stability of the file system 46 as a whole.

However, it may be advantageous for users to be able to modify or augment the functionality of the file system 46. For this reason, operating systems, such as those in the applications 22, may be configured to enable file system stacking. a stacked file system, such as the file system 46, allow additional file system functionality to be added by “stacking” additional modules “on top of” the file system 46 through a kernel of the operating system. Because the stacked modules are not part of the file system 46 itself, they can be added without affecting the underlying stability of the file system 46 (i.e., the stacked modules can be removed if they create instability without requiring recompilation of the file system 46).

These stacked modules are typically configured to receive instructions and data for the file system 46 and to generally pass through these instructions and data to the file system 46. However, except where the instruction relates to the stacked modules programming, the stacked module may take action. In other words, the stacked modules intercept/monitor instructions and data enroute to and from the file system 46 and, when programmed, modify and/or record the data. For example, in one embodiment, the trace module 48, which is stacked above the file system 46, may be configured to monitor and/or record characteristics of inputs and outputs to and from the file system 46. More specifically, the trace module 48 may be configured to record data about file access patterns, such as a type of file operation (e.g., read or write) and/or the amount of data that was involved (e.g., 4 kilobytes, 8 kilobytes, and so-forth). The trace module 48 may then be configured to store this information in trace logs 52. For example, in one embodiment, the trace logs 52 may be stored in the data storage device 24. As will be described further below, in one embodiment, the trace logs 52 may be accessed by a tuning daemon 54 that is configured to automatically adjust the settings of the file system 46 based on the information stored in the trace logs 52. Alternatively, the trace logs 52 may be accessed by a user to evaluate the performance of the file system 46. Collectively, the trace module 48, the trace logs 52, and the tuning daemon 54 may be referred to as tuning system 56.

As described above, the tuning daemon 54 may be configured to read the trace logs 52 and to adjust the settings of the file system 46 based on the information stored in the trace logs 52. For example, the tuning daemon 54 may be configured to automatically adjust the tunable parameter “max_buf_datasize.” As those of ordinary skill in the art will appreciate, the parameter “max_buf_datasize” has two possible settings: 8 kilobytes (“K”) and 64K. The 8K setting may be more efficient for applications that process data in small pieces (e.g., less than 8K), whereas the 64K setting is more efficient for applications that process data in larger pieces (i.e., greater than 8K). Accordingly, the tuning daemon 54 may be configured to read the trace logs 52 and determine the average size of data moving through the file system 46. In one embodiment, the average may be taken over a particular number of reads or writes (e.g., 10) or over a particular period of time (e.g., 30 seconds). However, in alternate embodiments, the other suitable averaging techniques may be used.

If the average size of the data is less a threshold value (e.g., 8K, 64K), the tuning daemon may set the “max_buf_datasize” parameter to 8K, and if the average size exceeds the threshold, the tuning daemon 54 may set the “max_buf_datasize” parameter to 64K. It will be appreciated, however, that in alternate embodiments, the threshold value may be another suitable value. Moreover, in still other embodiments, averaging the size of data blocks flowing through the file system 46 is merely one possible algorithm for selecting an appropriate setting for “max_buf_datasize.” As such, in alternate embodiments, the tuning daemon 54 may employ other suitable techniques including, but not limited to, a weighted average, medians, means, and so-forth.

Moreover, the tuning daemon 54 may be configured to automatically adjust one or more suitable tunable parameters based on the information read from the trace logs 46. For example, in alternate embodiments, the running daemon 54 may be configured to automatically adjust any of the following suitable parameters: a preferred read request size (“read_pref_io”), a preferred write request size (“write_pref_io”), a number of parallel read requests(“read_nstream”) a number of parallel write requests (“write_nstream”), a indirect extent size (“default_indir_size”), a discovered direct IO threshold (“discovered_direct_iosz”), a hierarchical storage management write preallocation size (“hsm_write_prealloc”), a default initial extent size (“initial_extent_size”), a maximum size for direct IO requests (“max_direct_iosz”), a maximum disk space size for a single queue (“max diskq”), a maximum size of an extent (“max_seqio_extent_size”), a read ahead cache setting (“read_ahead”), and a maximum number of dirty buffers per file value (“write_throttle”).

It will be appreciated that the tuning daemon 54 may be configured to automatically adjust one or more of the above-listed tunable parameters based upon criteria for that particular parameter. For example, as described above, the “max_buf_datasize” parameter may be adjusted based on the average size of data blocks moving through the file system 46; whereas the “read_pref_io” parameter may be adjusted based upon a number of sequential reads by the file system 46. Still others of the above-listed tunable parameters may be adjusted based on other suitable operational characteristics.

Moreover, in one embodiment, the tuning daemon 54 may be configured to automatically adjust one of parameters, monitor the effect of the adjustment on the performance of the file system 46, and adjust the parameter again. In this way, the tuning daemon 54 may be able “learn” the best threshold for a particular parameter. More specifically, over time, the tuning daemon 54 may itself learn which of the settings is fastest for a particular application activity pattern.

Moreover, in one embodiment, the tuning daemon 54 may alternatively be configured to monitor the trace logs 52, but to await authorization from a user to make adjustments to one or more of the tunable parameters. For example, the tuning daemon 54 may be configured to analyze the trace logs 52 and to recommend adjustments (e.g., in the form of a data file) to the tunable parameters based upon the information stored in the trace logs 52. In one embodiment, the tuning daemon 54 may be configured to display the recommended adjustments on the display 20 of FIG. 1. A user could then select one or more recommended adjustments for the tuning daemon 54 to implement. Alternatively, the user could make the recommended adjustments themselves.

Moreover, because the trace module 48 is a stacked module that can be added and removed from the system 40 on demand, system administrators may be able to employ the tuning system 56 as a diagnostic tool for the computer system 10 (see FIG. 1). More specifically, a system administrator may stack the trace module 48 onto the file system 46 and load the tuning daemon 54 onto the computer system 10. The trace module 48 may then be left to monitor input/output transactions to and from the file system 46 for a period of time. At the conclusion of that period of time, the tuning daemon 54 may be activated to analyze the trace logs 52 generated by the trace module 48 and to make and/or propose adjustments to one or more of the tunable parameters of the file system 46. After making the adjustments, the tuning system 56 may be removed from the computer system 10.

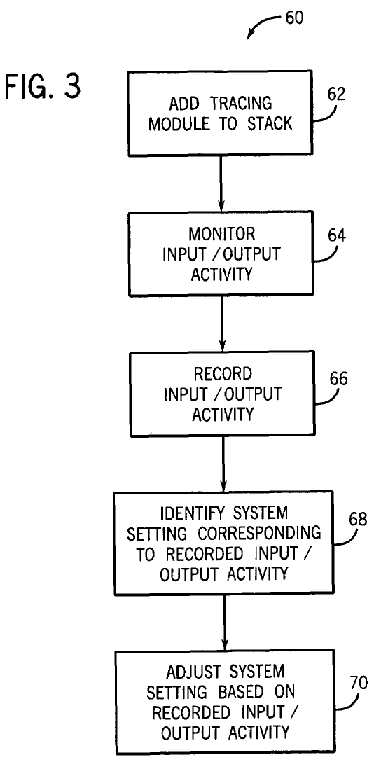

As described above, the tuning system 56 may be configured to automatically adjust file system settings. Accordingly, FIG. 3 is a flow chart illustrating an exemplary technique 60 for automatically adjusting file system settings in accordance with one embodiment. In one embodiment, technique 60 may be executed by the computer system 10 and/or the system 40.

As indicated by block 52 of FIG. 3, the technique 60 may begin by adding the tracing module 48 to the file system's 46 stack. Once added to the file system's 46 stack, the trace module 48 may be configured to monitor input and output activity to and from the file system 46, as indicated by block 64. In addition, the technique 60 may also involve recording the input and output activity in a log, such as the trace logs 52 (block 66). In one embodiment, the technique 60 may involve adding all or part of the tuning system 56 to the computer system 10.

Once input/output activity is recorded, the technique 60 may also include identifying one or more system settings that correspond to the recorded input and output data, as indicated by block 68. In one embodiment, this identification may be performed by the tuning daemon 54 (see FIG. 2). Lastly, the technique 60 may include adjusting one or more file system settings based on the recorded input and output data, as indicated by block 70. In one embodiment, adjusting the system settings may include the tuning daemon 54 automatically adjusting one or more tunable file system parameters. In alternate embodiments, adjusting the system settings may be performed by a system administrator or other user.

Moreover, in still other embodiments, adjusting the system setting may include adjusting other settings besides the tunable file system settings. For example, if all file systems 46 on one computer system are completely saturated with excessive activity, the tuning daemon 54 could be configured to communicate with higher level workload management tools to tell them not to schedule any more work on that computer system for a while. Alternatively, information could be used to set other tunable parameters to reduce the memory consumed by other areas of the system to allow more memory to be used by the file system 46.

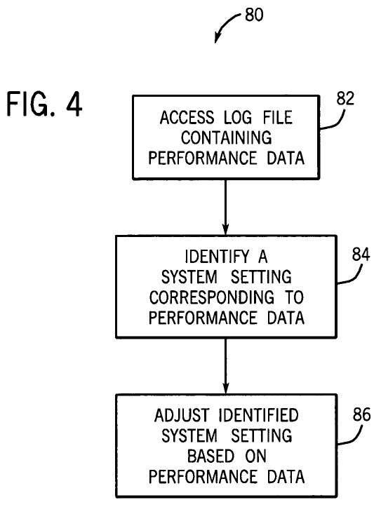

As described above, in one embodiment, the tuning daemon 54 may be configured to automatically adjust one or more tunable file system parameters based upon data stored in a log file (e.g., trace logs 52). Accordingly, FIG. 4 illustrates an exemplary technique 80 for automatically adjusting system settings based upon information stored in a log file in accordance with one embodiment. In one embodiment, the technique 80 may be performed by the tuning daemon 54 operating on the computer system 10.

As indicated by block 82 of FIG. 4, the technique 80 may begin by accessing a log file containing performance data. In one embodiment, block 82 may include accessing trace logs 52 containing input and output data from the file system 46. In alternate embodiments, however, the accessed trace log 52 may include other types of performance data, such as access times, memory efficiency, and so-forth.

Next, technique 80 may include identifying a system setting that corresponds to the performance data stored in the log file, as indicated by block 84. For example, in one embodiment, identifying the system setting may include determining whether the log file contains performance data related to the number of sequential reads by a file system 46. If a log file does include performance data containing a number of sequential reads, identifying the system setting may include identifying the tunable parameter of “read_pref_io,” for example after identifying one or more system settings corresponding to the performance data, the technique 80 may involve adjusting the identified system setting based on the performance data, as indicated by block 86.

As set forth above, one or more of the embodiments described herein may be directed towards a system or method for adjusting system parameters, such as tunable file system parameters. More specifically, one or more of the embodiments provides a tuning system 56 that can be manufactured and sold separately from the file system 46 and added to the computer system 10 and/or the system 40 when desired. Advantageously, this feature enables file system efficiency to be increased without having to rewrite features of the file system 46. Moreover, because the trace module 48 and the tuning daemon 54 are separate from the file system 46, the trace module 48 and the tuning daemon 54 can be customized relatively easily to a wide variety of suitable file systems 46.

While the invention described above may be susceptible to various modifications and alternative forms, specific embodiments have been shown by way of example in the drawings and have been described in detail herein. It should be understood, however, that the invention is not intended to be limited to the particular embodiments disclosed.

What is claimed:

1. A method comprising:
accessing a data file containing performance data for a computer, wherein the data file was created by a stacked module;
identifying a setting of the computer associated with the performance data; and
automatically adjusting the setting based on the performance data.

2. The method, as set forth in claim 1, wherein identifying the setting comprises identifying a file system setting.

3. The method, as set forth in claim 2, wherein identifying the file system setting comprises identifying a setting for the maximum buffer data size.

4. The method, as set forth in claim 3, comprising:
averaging the performance data over a period of time;
comparing the averaged performance data to a threshold value associated with maximum buffer size; and
automatically adjusting the maximum buffer size if the averaged performance data exceeds the threshold value.

5. The method, as set forth in claim 4, wherein the automatically adjusting comprises automatically adjusting the maximum buffer size to 64 kilobytes if an average data size exceeds 8 kilobytes.

6. A system comprising:
a file system
a module coupled to and separate from the file system, the module configured to intercept one or more transmissions to the file system and to store one or more characteristics of the transmissions in a log file; and
a tuning component coupled to the log file, the tuning component configured to:
access the one or more characteristics stored in the log file;
identify a setting of the file system related to the accessed characteristics; and
automatically determine a recommended adjustment to the setting of the file system based on the characteristic stored in the log file.

7. The system, as set forth in claim 6, comprising automatically performing the recommended adjustment.

8. The system, as set forth in claim 6, comprising a data file, wherein the data file includes the recommended adjustment.

9. The system, as set forth in claim 6, wherein the file system comprises VxFS.

10. The system, as set forth in claim 6, wherein the module is configured to stack onto the file system.

11. A tangible machine readable medium comprising:
code adapted to be stacked onto a file system, wherein the code comprises instructions for:
intercepting one or more transmissions to the file system; and
storing one or more characteristics of the transmissions in a log file; and
code adapted to access the log file;
code adapted to identify a setting of the file system associated with the one or more characteristics stored in the log file; and
code adapted to adjust the setting based on the one or more characteristics.

12. The tangible medium, as set forth in claim 11, wherein the code adapted to identify the setting comprises code adapted to identify a setting associated with a maximum buffer data size.

13. The tangible medium, as set forth in claim 11, wherein the code adapted to identify the setting comprises code adapted to identify a maximum buffer size parameter.

14. The tangible medium, as set forth in claim 11, wherein the code adapted to access the log file comprises a tuning daemon.

15. The tangible medium, as set forth in claim 11, wherein the code adapted to be stacked onto the file system comprises code adapted to be stacked onto VxFS.

16. A tuning system for a computer file system comprising:
a trace module configured to be stacked onto the file system and to generate a log file containing data intercepted enroute to the file system; and
a tuning module configured to automatically adjust one or more file systems setting based one or more characteristics of the intercepted data.

17. The tuning system, as set forth in claim 16, comprising one or more log files configured to store the one or more characteristics of the intercepted data.

18. The tuning system, as set forth in claim 17, wherein the one or more characteristics of the intercepted data comprise a data size.

19. The tuning system, as set forth in claim 16, wherein the trace module s configured to transmit the intercepted operational data onto the file system.
